(19) United States
(12) Patent Application Publication
(10) Pub. No.: US 2006/0283265 A1
(43) Pub. Date: Dec. 21, 2006

(54) Torque wrench

(75) Inventor: Nobuyuki Izumisawa, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: KABUSHIKI KAISHA SHINANO SEISAKUSHO

(21) Appl. No.: 11/447,849

(22) Filed: Jun. 7, 2006

(30) Foreign Application Priority Data
Jun. 15, 2005 (JP) JP2005-174569

(51) Int. Cl. B25B 23/14; G01L 5/24

(52) U.S. Cl. 73/862.22

(57) ABSTRACT

A torque wrench is configured such that power supplied from an air motor is transmitted to a ratchet unit via a reduction gear unit in order to rotate a spindle connected to the ratchet unit. The torque wrench includes a ratchet housing accommodating the ratchet unit, a body coupled with the ratchet housing and accommodating the air motor, a strain gage bonded to the ratchet housing, a battery box accommodated within the body, and a circuit board fixed to a housing cover covering the ratchet housing and having a torque adjustment circuit provided thereon. The circuit board is connected to the battery box via a conductive wire running though a wiring groove formed on the body. Leads of the strain gage are connected to the circuit board within the housing cover.

### BACKGROUND OF THE INVENTION

1. Field of the Invention

The present invention relates to a ratchet-wrench-type torque wrench which can adjust tightening torque to a predetermined torque range.

2. Background of the Invention

Japanese Patent Application Laid-Open (kokai) No. 2003-136418 discloses a conventional ratchet-wrench-type torque wrench which enables manual tightening of a threaded fastening member, such as a bolt or a nut, to a predetermined tightening torque to be performed accurately and easily after the threaded fastening member is quickly tightened through motor drive until the threaded fastening member seats on an engagement surface. In the ratchet-wrench-type torque wrench, the tightening torque is adjusted by means of a mechanical torque adjustment mechanism.

Specifically, when a threaded fastening member is manually tightened to a predetermined tightening torque, a hollow handle and a sleeve member come into engagement with each other to produce a hitting sound; i.e., a “click.” Therefore, upon hearing the hitting sound, a worker who holds a grip portion of the torque wrench can know that tightening of the threaded fastening member is completed.

However, in the mechanical torque adjustment mechanism, the tightening torque is adjusted through adjustment of engagement force between first and second projections produced by means of repulsive force of an adjustment coil spring, the engagement force being adjusted by moving in the front-rear direction an adjustment nut in screw-engagement with a male screw portion of the hollow handle. Therefore, the torque adjustment mechanism must be calibrated at a frequency of at least once a year or so.

### SUMMARY OF THE INVENTION

In consideration of the above-described problem of the conventional art, an object of the present invention is to provide a torque wrench including an electronic torque adjustment means which greatly reduces the frequency of calibration as compared with a torque wrench equipped with a mechanical torque adjustment means which requires calibration to be performed at a frequency of at least once a year or so.

In order to achieve the above object, the present invention provides a torque wrench in which power supplied from an air motor is transmitted to a ratchet unit via a reduction gear unit in order to rotate a spindle connected to the ratchet unit, comprising a ratchet housing within which the ratchet unit is accommodated; a body which is coupled with the ratchet housing and within which the air motor is accommodated; a strain gage bonded to the ratchet housing; a battery box accommodated within the body; and a circuit board which is fixed to a housing cover covering the ratchet housing and on which torque adjustment means is provided, wherein the circuit board is connected to the battery box via a conductive wire running though a wiring groove formed on the body, and leads of the strain gage are connected to the circuit board within the housing cover.

Preferably, the strain gage is bonded to a flat surface formed on one side face of the ratchet housing, and the flat surface perpendicularly intersects a rotation plane of the spindle, the rotation plane being perpendicular to a center axis of the spindle. More preferably, the strain gage is bonded to each of two flat surfaces formed on opposite side faces of the ratchet housing.

Preferably, a plurality of LEDs for displaying a predetermined torque range are mounted on the circuit board, and a display panel for covering the circuit board is provided on the housing cover.

Preferably, a switch for activating the circuit board is provided on the housing cover.

Preferably, an air vent is formed in the body in the vicinity of the air motor, and a cylindrical deflector for covering the air vent is attached to the body to be slidable in the circumferential direction.

In the torque wrench of the present invention, the strain gage is bonded to the ratchet housing, and the circuit board carrying electronic torque adjustment means is fixed to the housing cover which covers the ratchet housing. Therefore, when a worker tightens a threaded fastening member. to a predetermined tightening torque, the torque adjustment means informs him or her of completion of the tightening operation. In addition, the frequency of calibration of the torque adjustment means decreases. Moreover, the torque wrench of the present invention can have a slim and neat shape.

### BRIEF DESCRIPTION OF THE DRAWINGS

FIG. 1 is a vertical sectional view of a torque wrench according to an embodiment of the present invention;

FIG. 2 is a plan view of the torque wrench of FIG. 1 with the housing cover removed;

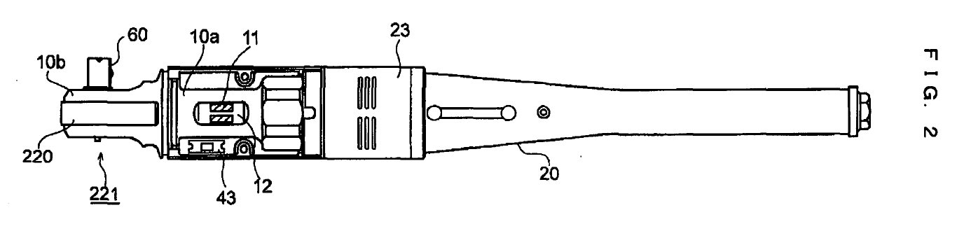

FIG. 3 is a plan view of the torque wrench of FIG. 1; and

FIG. 4 is an enlarged view of a display panel.

### DESCRIPTION OF THE PREFERRED EMBODIMENT

An embodiment of the present invention will be described with reference to the drawings.

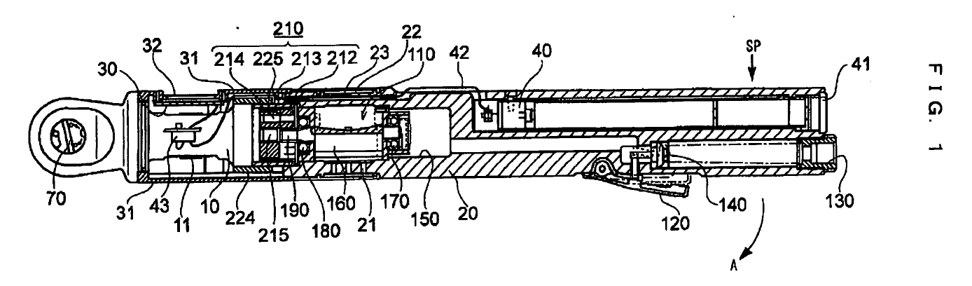

As shown in FIG. 1, in a torque wrench according to the present embodiment, power supplied from an air motor 110 is transmitted to a ratchet unit 221 via a reduction gear unit 210, whereby a spindle 60 connected to the ratchet unit 221 is driven.

The ratchet unit 221 is accommodated within a ratchet housing 10. The ratchet housing 10 is composed of a hollow portion 10a for accommodating a crankshaft and a yoke insertion portion 10b. A body 20, which accommodates the air motor 110, is coupled with the ratchet housing 10 by means of a lock ring 224.

Strain gages 11 are bonded to the ratchet housing 10. Specifically, two opposed flat surfaces 12 are formed on the opposite outer side faces of the hollow portion 10a of the ratchet housing 10, and the strain gages 11 are bonded to the flat surfaces 12. The flat surfaces 12 perpendicularly intersect the rotation plane of the spindle 60 (plane which is parallel to the sheet of FIG. 1 and perpendicular to the center axis of the spindle).

The reason why the flat surfaces 12 are made to perpendicularly intersect the spindle rotation plane is that when a worker manually tightens a nut or the like while grasping a reference point SP (see FIG. 1) of the body 20; i.e., when the body 20 is rotated in a rotation direction A in FIG. 1 about the spindle 60, the strain produced at the flat surfaces 12 of the hollow portion lOa of the ratchet housing 10 is maximized, and thus, the strain gages 11 exhibit high sensitivity.

Since the flat surfaces 12 perpendicularly intersect the rotation plane of the spindle 60, when the body 20 is manually rotated in the rotation direction A, the upper strain gage 11 in FIG. 1 is extended, and the lower strain gage 11 in FIG. 1 is contracted.

A battery box 40 is accommodated in the body 20. In the present embodiment, the battery box 40 accommodates three size AA batteries. However, the battery box itself may be a rechargeable battery. The size AA batteries are placed in the battery box 40 after removal of a cap 41 at an end of the battery box 40 near an air introduction portion 130.

A circuit board 30, on which torque adjustment means is provided, is secured to a housing cover 31, which covers the ratchet housing 10. A plurality of LEDs (not shown) for displaying a predetermined torque adjustment range are mounted on the circuit board 30, and a display panel 32 for covering the circuit board 30 is provided on the housing cover 31. Further, a switch 43 for activating the torque adjustment means on the circuit board 30 is provided on the housing cover 31.

The circuit board 30 is connected via the switch 43 with the battery box 40 by means of a conductive wire 42 running through a wiring groove formed on the body 20. Lead wires of the strain gages 11 are connected with the circuit board 30 within the housing cover 31.

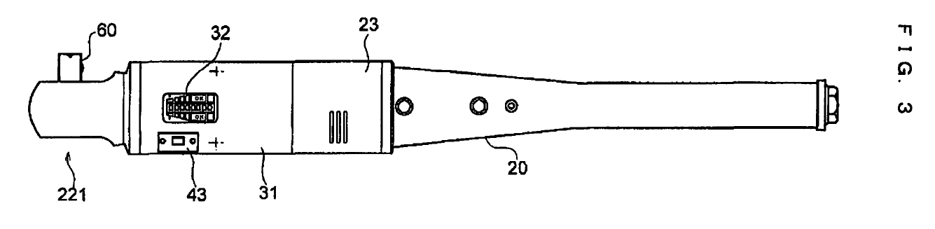

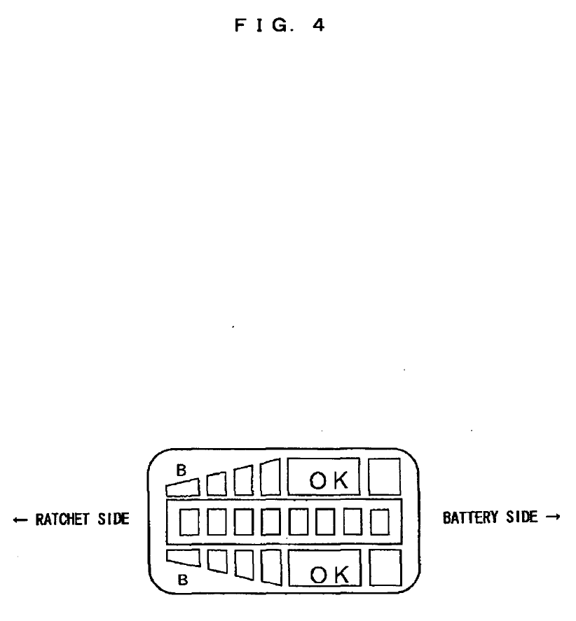

As shown in FIGS. 3 and 4, the display panel 32 includes upper, center, and lower display sections. The above-mentioned LEDs are disposed on the reverse side of the center display section, and the upper and lower display sections are printed by means of facing printing.

While viewing the display panel 32, a worker adjusts the tightening torque of the torque wrench to a predetermined torque range. The procedure thereof will be described below. Batteries are loaded in the battery box 40, an air hose is connected to the air introduction portion 130, and the switch 43 is turned on. The torque adjustment means is programmed so as to check the batteries at the time of startup. When the batteries are fully charged, all the LEDs are turned on. The LEDs indicate the remaining amount of charge. Further, replacement of the batteries is prompted by a “B” mark.

After a worker activates the torque wrench and tightens a nut, for example, through air motor drive until the nut seats on an engagement surface, the worker manually tightens the nut while grasping the torque wrench at the reference position SP. As a result, the LEDs are successively turned on from the ratchet side. When one or more LEDs in an “OK” zone are turned on, the worker ends the manual tightening. In FIG. 4, four LEDs on the ratchet side are red, three LEDs in the OK zone are blue, and one LED located on the battery side and indicating “excessive torque” is red.

Of the tree blue LEDs in the OK zone, the LEDs located on the opposite sides of the center LED are turned on at torque values which are 10% higher and lower than the reference tightening torque at which the center LED is turned on. For example, the torque adjustment means is programmed to control the three blue LEDs in the OK zone as follows:
(1) the ratchet-side LED is turned on at 93.1 N·m (9.5 kg·m);
(2) the center LED is turned on at 102.9 N·m (10.5 kg·m); and
(3) the battery-side LED is turned on at 112.7 N·m (11.5 kg·m).

Since the torque adjustment means is programmed as described above, the OK zone can be set to a torque range desired by a user. However, setting is not performed by the user, but is performed by a manufacturer through modification of the program.

In FIG. 1, reference numeral 110 denotes the air motor. When pressurized air is introduced from the air introduction portion 130 to the air motor 110 via an open-close valve 140 as a result of operation of an open-close lever 120, a rotor body 160 of the air motor 110 rotates within a motor housing 150 formed in the body 20, whereby a shaft 190 rotates. The pressurized air is discharged to the outside of the body 20 via air vents 21 formed in the body 20 in the vicinity of the air motor 110. The air vents 21 are covered with a sound-deadening muffler 22, and further covered with a cylindrical deflector 23. The deflector 23 is attached to the body 20 to be slidable in the circumferential direction. Notably, a portion of the body 20 where the battery box 40 is formed serves as a gripping portion; i.e., a handle, of the torque wrench.

The rotor body 160 of the air motor 110 is rotatably journaled by means of bearings 170 and 180 fixedly disposed within the motor housing 150. The rotor body 160 has the shaft 190, which is jurnaled by means of the bearing 180. A distal end portion of the shaft 190 is in meshing engagement with the reduction gear unit 210.

The reduction gear unit 210 includes three idle gears 212, an internal gear 213, and a cage 214. The idle gears 212 are in meshing-engagement with the shaft 190. The internal gear 213 is in meshing-engagement with the idle gears 212 and is fixed to the ratchet housing 10, which is coupled with the motor housing 150 by means of the lock ring 224. The cage 214 is coupled with each of the idle gears 212 via a respective idle pin 225 and is in engagement with a crankshaft 215.

The three idle gears 212 are disposed around the output shaft 190. Each of the idle gears 212 is rotatably fixed onto the corresponding idle pin 225. The cage 214 is fixed to the idle pins 225 (three idle pins in the embodiment of FIG. 1), so that, when the idle gears 212 revolve around the shaft 190, the cage 214 rotates about its axis, and the crankshaft 215 rotates.

In the ratchet housing 10, the crankshaft 215 is rotatably supported by a bush (not shown) on the side toward the reduction gear unit 210 and a needle bearing (not shown) on the side toward the spindle 60.

The crankshaft 215 has a crank pin projecting from a tip end surface at an eccentric position. The crank pin is rotatably connected to a bush, which is rotatably fitted in a recess of a yoke 220. The yoke 220 is connected to the spindle 60 via the ratchet unit 221.

When a threaded fastening member, such as a bolt or nut, having a right-hand thread is tightened by use of the torque wrench having the above-described structure, an unillustrated socket attached to the spindle 60 is engaged with the threaded fastening member, and the open-close lever 120 is operated. As a result, the air motor 110 operates, and the shaft 190 rotates together with the rotor 160.

The rotation speed of the output shaft 190 is reduced through the reduction gear unit 210. Rotational motion of the shaft 190 is transmitted to the yoke 220 via the crankshaft 215, so that the yoke 220 swings repeatedly. The swinging motion of the yoke 220 is converted to rotary motion of the spindle 60 by the ratchet unit 221, whereby the right-hand-threaded fastening member is tightened. When the fastening member is to be loosened, or a threaded fastening member having a left-hand thread is to be tightened, the worker changes the direction of rotation of the spindle 60 through operation of a reverse lever 70.

In a torque wrench according to another embodiment of the present invention, the torque adjustment means can display not only rotational torque in the clockwise direction but also rotational torque in the counterclockwise direction. In the torque wrench according to this embodiment, when the torque wrench is rotated in the direction opposite the rotational direction A in FIG. 1, rotational torque in the counterclockwise direction is displayed. In a torque wrench according to still another embodiment of the present invention, the spindle 60 is provided on either side of the yoke. In this case, manual tightening is always performed in the rotational direction A irrespective of whether a threaded fastening member has a right-hand thread or a left-hand thread. In either case, since the torque wrench of the present invention displays torque by means of the electronic torque adjustment means, tightening torque can be displayed for both the right-hand-threaded fastening member and the left-hand-threaded fastening member. Conventional mechanical torque adjustment mechanism can check tightening torque only for one of right-hand-threaded and left-hand-threaded fastening members (e.g., a right-hand-threaded fastening member).

What is claimed is:

1. A torque wrench in which power supplied from an air motor is transmitted to a ratchet unit via a reduction gear unit in order to rotate a spindle connected to the ratchet unit, comprising:
a ratchet housing within which the ratchet unit is accommodated;
a body which is coupled with the ratchet housing and within which the air motor is accommodated;
a strain gage bonded to the ratchet housing;
a battery box accommodated within the body; and
a circuit board which is fixed to a housing cover covering the ratchet housing and on which torque adjustment means is provided, wherein
the circuit board is connected to the battery box via a conductive wire running though a wiring groove formed on the body, and leads of the strain gage are connected to the circuit board within the housing cover.

2. A torque wrench according to claim 1, wherein the strain gage is bonded to a flat surface formed on one side face of the ratchet housing, and the flat surface perpendicularly intersects a rotation plane of the spindle, the rotation plane being perpendicular to a center axis of the spindle.

3. A torque wrench according to claim 2, wherein the strain gage is bonded to each of two flat surfaces formed on opposite side faces of the ratchet housing.

4. A torque wrench according to claim 1, wherein a plurality of LEDs for displaying a predetermined torque range are mounted on the circuit board, and a display panel for covering the circuit board is provided on the housing cover.

5. A torque wrench according to claim 1, wherein a switch for activating the circuit board is provided on the housing cover.

6. A torque wrench according to claim 1, wherein an air vent is formed in the body in the vicinity of the air motor, and a cylindrical deflector for covering the air vent is attached to the body to be slidable in the circumferential direction.
